(19) United States
(12) Patent Application Publication
(10) Pub. No.: US 2010/0235295 A1
(43) Pub. Date: Sep. 16, 2010

(54) IDENTIFYING ONE OR MORE HEALTHCARE PROVIDERS

(76) Inventors: Amanda Zides, Washington, DC (US); Hardip Singh, Washington, DC (US)

Correspondence Address: FISH & RICHARDSON P.C., P.O. BOX 1022, MINNEAPOLIS, MN, 55440-1022, US

(21) Appl. No.: 12/443,946

(22) PCT Filed: Oct. 3, 2007
(86) PCT No.: PCT/US07/80349

§ 371 Date: Dec. 7, 2009

Related U.S. Application Data
(60) Provisional application No. 60/828,004, filed on Oct. 3, 2006.

(51) Int. Cl. G06Q 99/00; G06Q 50/00

(52) U.S. Cl. 705/347

(57) ABSTRACT

Users may be interested in identifying healthcare providers consistent with their needs. Systems and methods for identifying and presenting one or more healthcare providers to a user are disclosed. Various different metrics may be used to calculate the relative appropriateness of healthcare providers for a user. In order to identify healthcare providers that are particularly appropriate for a user, the metrics used to calculate the relative appropriateness of a healthcare provider may be customizable on a per user basis.

### TECHNICAL FIELD

This disclosure relates to identifying one or more healthcare providers for a user.

### BACKGROUND

Users may be interested in identifying healthcare providers consistent with their needs. Users may access a communications network, such as the Internet, to retrieve information regarding healthcare providers.

### SUMMARY

Systems and methods for identifying and presenting one or more healthcare providers to a user are disclosed. Various different metrics may be used to calculate the relative appropriateness of healthcare providers for a user. In order to identify healthcare providers that are particularly appropriate for a user, the metrics used to calculate the relative appropriateness of a healthcare provider may be customizable on a per user basis. That is to say, an individual user may select among and assign personalized weights to various metrics available for identifying potentially appropriate healthcare providers for the user. For example, factors that may be considered (and/or weighted) in determining the relative appropriateness of a particular healthcare provider for a user may include a healthcare provider's location, a healthcare provider's success rate in treating similarly situated patients (e.g., patients suffering from the same condition and in the same demographic as the user), estimated treatment costs, estimated travel costs, whether or not a healthcare provider accepts the user's health insurance, and/or a healthcare provider's preferred treatment strategy (e.g., traditional medical treatments versus alternative/homeopathic medical treatments).

In some implementations, potentially appropriate healthcare providers are identified to a user in a manner that enables the user to judge the healthcare providers' performance in treating similarly situated users. For example, for a patient that has been diagnosed with a potentially life threatening disease, potentially appropriate healthcare providers may be presented to a user along with indications of the different healthcare providers' success rates (e.g., cure rates) for other patients who faced the same or similar diagnosis and who match the user's demographic or otherwise match the user's profile.

In other implementations, potentially appropriate healthcare providers are identified to a user in a manner that enables the user to estimate the total cost associated with receiving treatment from each of the healthcare providers. For example, for each potentially appropriate healthcare provider, an estimated treatment cost for receiving treatment from the healthcare provider may integrate or otherwise account for (e.g., be presented alongside) an estimated travel cost associated with receiving treatment from the healthcare provider.

Presenting estimated travel costs in addition to estimated treatment costs to a user may help the user identify the most cost-effective healthcare provider, even if that healthcare provider is not local to the user. For example, consider a Washington, D.C. resident that has been diagnosed with melanoma. Under normal circumstances, the user may seek treatment for the melanoma from a healthcare provider in the Washington, D.C. area. Even if the user were aware that the world's top physician for treating melanoma was located in Houston, Tex., the user may not consider traveling from Washington, D.C. to Houston, Tex. for treatment. However, presenting total estimated treatment costs from one or more healthcare providers in the Washington, D.C. area and a total estimated treatment cost for the world-renowned melanoma specialist in Houston, Tex., may reveal to the user that the total estimated costs for receiving treatment from the world-renowned melanoma specialist in Houston, Tex. are actually less than or are comparable to the total estimated costs for receiving treatment from a physician in the Washington, D.C. area. In this situation, the user may be led to consider seeking treatment from the specialist in Houston, Tex., rather than from a local healthcare provider in Washington, D.C.

In another implementation, treatment options are identified to a user for treating a medical condition associated with the user. The treatment options may be determined by analyzing user profiles of other users who have suffered from the same medical condition. For example, treatment options used by other users to treat Melanoma may be presented to a user along with statistic relating to the projected success rate, cost, duration, and comfort level of the treatment option. In another implementation, healthcare providers are identified to the user based on the user's preferred treatment option.

### DESCRIPTION OF DRAWINGS

FIG. 1a is an illustration of an example of a graphical user interface for facilitating the identification of healthcare providers that are potentially appropriate for a user.

FIGS. 1b and 1c are illustrations of examples of graphical user interfaces for displaying a list of healthcare providers that have been identified as potentially being appropriate for a user.

FIGS. 2a and 2b are block diagrams illustrating healthcare provider profiles.

FIG. 3 is a flowchart of an example of a process for identifying and presenting potentially relevant healthcare providers to a user.

FIG. 4 is an illustration of an example of a graphical user interface that enables a user to customize weights assigned to metrics used to identify potentially appropriate healthcare providers for the user.

FIG. 5 is a flowchart of an example of a process for identifying appropriate healthcare providers for a user based on customized metrics.

FIG. 6 is an illustration of an example of a graphical user interface that enables a user to sort healthcare provider recommendations according to metrics selected by the user.

FIG. 7 is an illustration of an example of a graphical user interface that enables the user to learn more about a selected healthcare provider.

FIG. 8a shows a graph of the duration of time needed by a selected healthcare provider from initial examination to successful cure of a medical condition over a given number of years.

FIG. 8b shows a graph of the success rate of a selected healthcare provider in treating a selected medical condition over a given number of years.

FIG. 8c shows a graph of the success rate of a selected healthcare provider in treating a selected medical condition according to patient age.

FIG. 9 is a flowchart of an example of a process for selecting a healthcare provider according to treatment cost.

FIG. 10 is a flowchart of an example of a process for selecting a healthcare provider primarily according to success rate and reputation.

FIG. 11 is a flowchart of an example of a process for selecting a healthcare provider according the user ratings and reviews.

FIG. 12 is a flowchart of an example of a process for selecting a healthcare provider according to the user's preferred treatment option.

FIG. 13 is an illustration of an example of a graphical user interface that enables a user to limit the user profiles to be searched.

FIG. 14 is an illustration of an example of a graphical user interface that displays the recommended treatment options to a user.

FIG. 15 is an illustration of an example of a graphical user interface that displays the projected outcome of a selected treatment option to the user.

FIG. 16 is an illustration of an example of a graphical user interface that displays the identified healthcare providers to a user.

FIG. 17 is an example of a system for identifying healthcare providers.

### DETAILED DESCRIPTION

Users may rely on a health portal to manage healthcare needs for users and their families. For example, a health portal may be configured to improve the identification of appropriate healthcare providers. In addition, the health portal may provide tools that assist a user in managing a medical condition (e.g., melanoma), for example, by tracking the user's condition using different metrics, suggesting relevant information, and enabling the user to perceive the progress of other, similarly-situated users.

The health portal may identify and display healthcare providers based on characteristics of healthcare providers (e.g. location, aggregate cost, health insurance accepted, reputation, and success rate) a user finds most important. A user may view additional information (e.g. success rate, treatment cost, and reputation) about each identified healthcare provider to select an appropriate healthcare provider. The aggregate treatment cost for each healthcare provider may include the healthcare provider's estimated treatment costs including insurance deductibles, medication, and rehabilitation costs and the estimated travel costs including work downtime, meals, and housing during treatment. In addition, information, such as healthcare provider reviews shared between users of the health portal may be utilized by a user to select an appropriate healthcare provider. As a result, a user may select a healthcare provider outside of the user's hometown who has a lower aggregate cost and better user reviews over a healthcare provider located in the user's hometown.

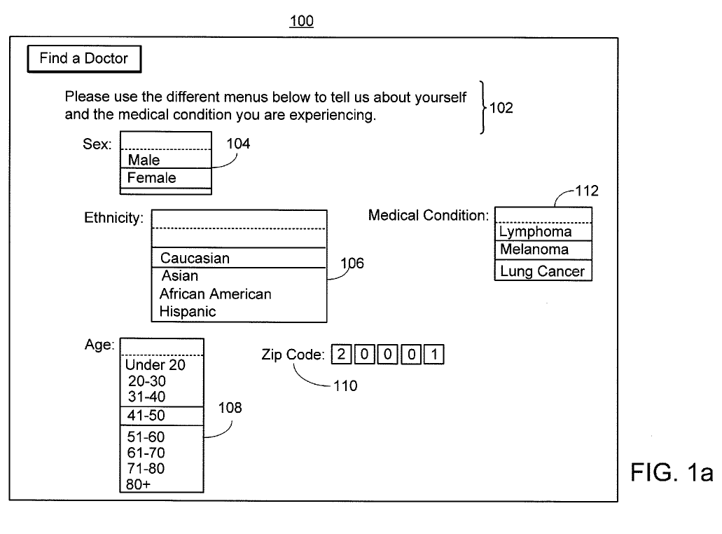

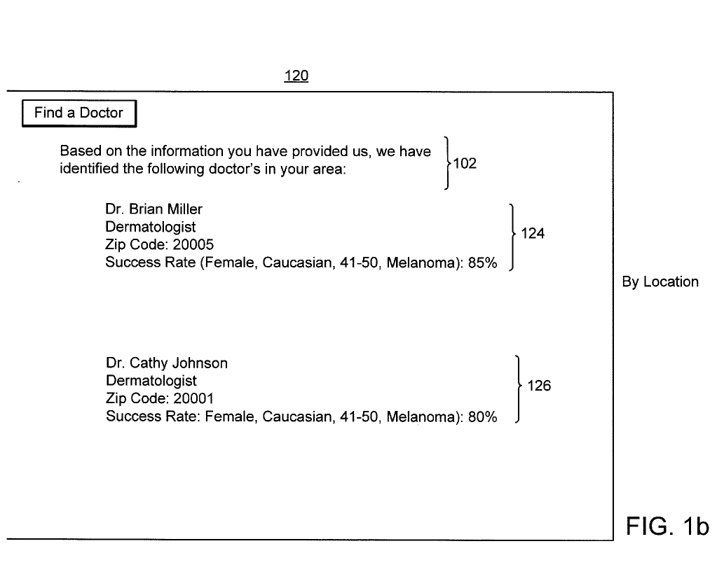

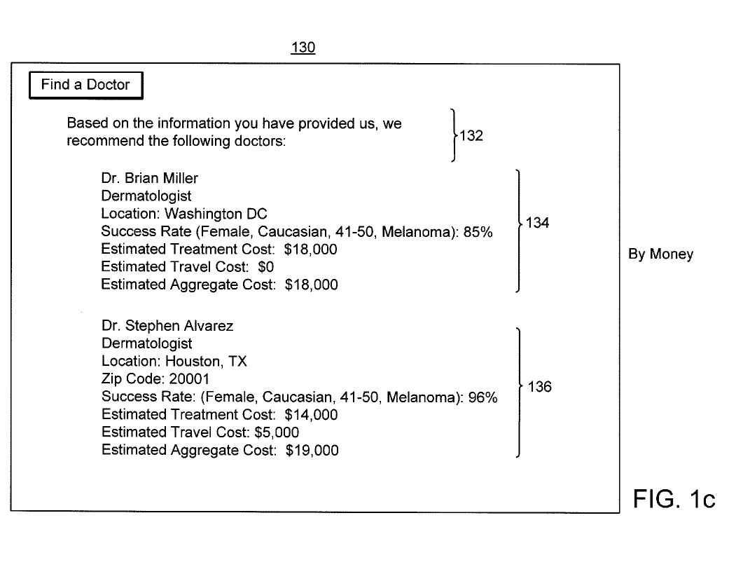

FIG. 1a is an illustration of an example of a graphical user interface (GUI) 100 for facilitating the identification of healthcare providers that are potentially appropriate for a user. GUI 100 of FIG. 1a includes a text block 102, a first drop down menu 104 that enables the user to input the user's sex, a second drop down menu 106 that enables the user to input the user's ethnicity, a third drop down menu 108 that enables the user to input the user's age, a zip code entry field 110 that enables the user to input the user's zip code, and a fourth drop down menu 110 that enables the user to select a medical condition. In another example, the GUI 100 may enable a user to input the user's home and/or work address. As illustrated in FIG. 1a, the user has indicated that she is a Caucasian female, between the ages of 41-50 years old, living in the 20001 zip code. In addition, the user has indicated that she is looking for a healthcare provider qualified to treat melanoma. Based on the information provided by the user in GUI 100 of FIG. 1a, a search of a database of healthcare providers is performed to identify healthcare providers that may be appropriate for the user. In another example GUI 100 may, additionally or alternatively, enable the user to input other information related to the user, such as, for example, occupation, income, marital status, and/or information regarding the health condition of the user's parents.

FIG. 1b is an illustration of an example of a GUI 120 for displaying a list of healthcare providers that have been identified as potentially being appropriate for a user. More particularly, the GUI 120 of FIG. 1b presents a list of healthcare providers that have been identified as potentially relevant for a user based on the information input into the GUI 100 of FIG. 1a. GUI 120 includes a text block 122 that introduces the information to be presented by the GUI 120, a first healthcare provider recommendation 124, and a second healthcare provider recommendation 126. Each of the healthcare provider recommendations 124 and 126 identifies the healthcare provider's name, the type of medicine the healthcare provider practices, the healthcare provider's location, and the healthcare provider's success rate in treating other similarly situated patients.

As illustrated in FIG. 1b, the first healthcare provider recommendation 124 identifies Dr. Brian Miller's success rate in treating Caucasian females between the ages of 41-50 years old as 85% and the second healthcare provider recommendation 126 identifies Dr. Cathy Johnson's success rate in treating Caucasian females between the ages of 41-50 years old as 80%. Presenting the individual healthcare providers' success rates in treating other similarly situated patients may enable the user to make a more informed decision when selecting a healthcare provider than would be possible if the individual healthcare providers' success rates in treating other similarly patients were not presented.

FIG. 1c is an illustration of a second example of a GUI 130 for displaying a list of healthcare providers that have been identified as potentially being appropriate for a user. More particularly, the GUI 130 of FIG. 1c presents a list of healthcare providers that have been identified as potentially relevant for a user based on the information input into the GUI 100 of FIG. 1a. GUI 130 includes a text block 132 that introduces the information to be presented by the GUI 130, a first healthcare provider recommendation 134, and a second healthcare provider recommendation 136.

Each of the healthcare provider recommendations 134 and 136 identifies the healthcare provider's name, the type of medicine the healthcare provider practices, the healthcare provider's location, the healthcare provider's success rate in treating other similarly situated patients, the estimated treatment costs for receiving treatment from the healthcare provider, the estimated travel costs associated with traveling to receive treatment from the healthcare provider, and the estimated aggregate cost of receiving treatment from the healthcare provider for the user, including, for example, both the healthcare provider's estimated treatment costs and the estimated travel costs associated with traveling to receive treatment from the healthcare provider. While each of the healthcare provider recommendations 134 and 136 present only a single success rate corresponding to the healthcare provider's success rate in treating a single demographic group, multiple success rates corresponding to the healthcare provider's success rates in treating different groups of similarly situated patients also may be presented. Additionally or alternatively, a particular healthcare provider's success rates in treating similar and/or related conditions also may be presented.

As illustrated in FIG. 1c, the first healthcare provider recommendation 134 identifies Dr. Brian Miller's success rate in treating Caucasian females between the ages of 41-50 years old as 85%. In addition, the first healthcare provider recommendation 134 estimates Dr. Brian Miller's treatment costs as $18,000, the travel costs associated with traveling to receive treatment from Dr. Brian Miller as $0, and the aggregate cost for the user to receive treatment from Dr. Brian Miller as $18,000. The estimated travel costs are $0 because both the user and Dr. Brian Miller are located in the Washington, D.C. area. The second healthcare provider recommendation 136 identifies Dr. Stephen Alvarez's success rate in treating Caucasian females between the ages of 41-50 years old as 96%. In addition, the second healthcare provider recommendation 136 estimates Dr. Stephen Alvarez's treatment costs as $14,000, the travel costs associated with traveling to receive treatment from Dr. Stephen Alvarez as $5,000, and the aggregate cost for the user to receive treatment from Dr. Stephen Alvarez as $19,000. The estimated travel costs for receiving treatment from Dr. Stephen Alvarez are much higher than the estimated travel costs for receiving treatment from Dr. Brian Miller because in order for the user to receive treatment from Dr. Stephen Alvarez, the user will have to travel from Washington, D.C. to Houston, Tex.

A comparison of the first healthcare provider recommendation 134 with the second healthcare provider recommendation 136 reveals that the estimated aggregate cost for receiving treatment from Dr. Stephen Alvarez is $1,000 more expensive than the estimated aggregate cost for receiving treatment from Dr. Brian Miller. However, such a comparison also reveals that Dr. Stephen Alvarez's success rate is much higher than Dr. Brian Miller's success rate in treating Caucasian females between the ages of 41-50 years old. Because Dr. Stephen Alvarez's success rate in treating other patients that are similarly situated to the user is significantly higher than Dr. Brian Miller's success rate, the user may determine that it is worth the extra $1,000 to seek treatment from Dr. Stephen Alvarez instead of Dr. Brian Miller. Presenting the estimated aggregate costs, including travel costs, associated with receiving treatment from individual healthcare providers may enable a user to make a more informed decision when selecting a healthcare provider than would be possible if the estimated aggregate costs, including travel costs, were not presented. For example, if the estimated aggregate costs, including travel costs, had not been presented, the user may not have considered seeking treatment from Dr. Stephen Alvarez. Instead, the user may have restricted her search to local healthcare providers.

The estimated aggregate costs illustrated in FIG. 1c may include other factors in addition to the healthcare providers' estimated treatment costs and the estimated costs associated with traveling to the healthcare providers. For example, an estimated aggregate cost for a particular healthcare provider may include such factors as work downtime due to traveling to the particular healthcare provider, insurance networks in which the healthcare provider participates and resultant costs to the user whose insurance is known, food costs, and/or housing cost. Food and housing costs may be calculated based on the location of the healthcare provider and the average treatment duration for the particular treatment the user selects. Therefore, each of the aggregate cost entries illustrated in FIG. 1c may be selectable so as to enable a user to perceive a breakdown of the various costs that contributed to the estimated aggregate cost for receiving treatment from a particular healthcare provider.

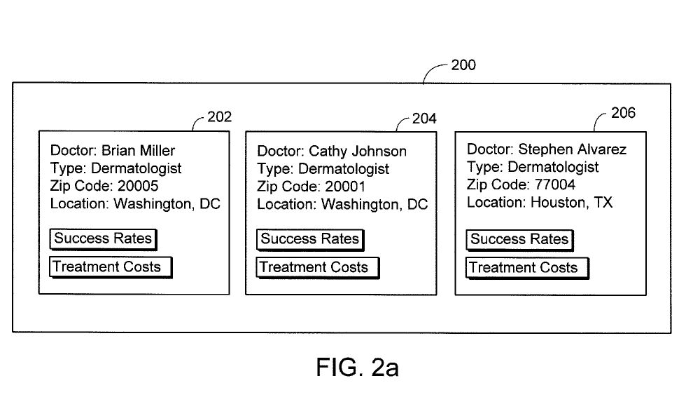

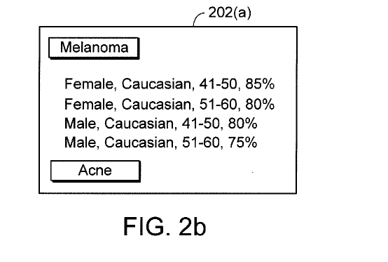

FIG. 2a is a block diagram of a collection of healthcare provider profiles 200. The collection of healthcare provider profiles 200 includes a first healthcare provider profile 202 associated with Dr. Brian Miller, a second healthcare provider profile 204 associated with Dr. Cathy Johnson, and a third healthcare provider profile 206 associated with Dr. Stephen Alvarez.

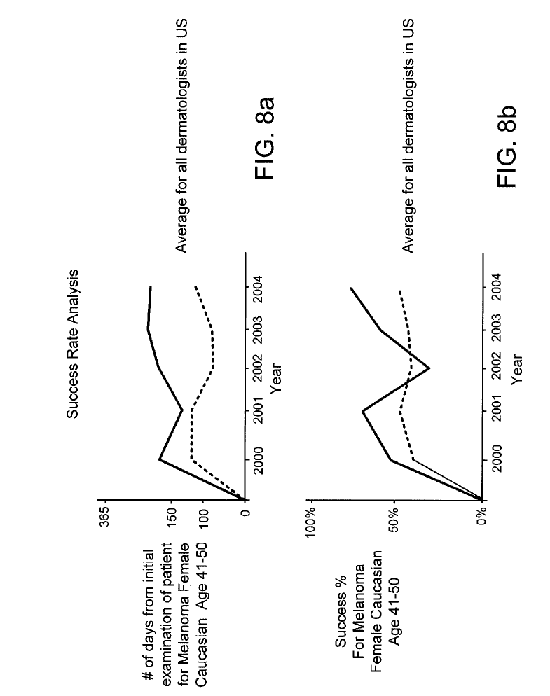

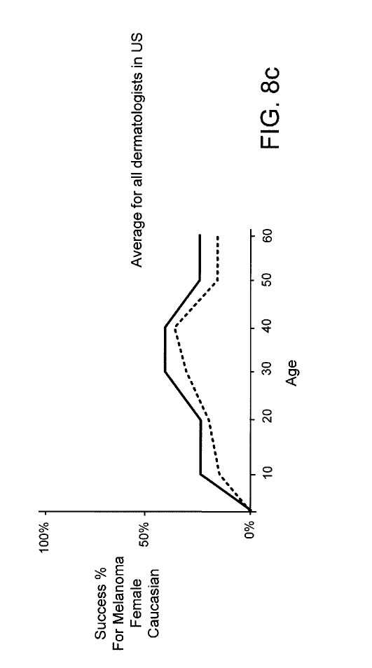

As illustrated in FIG. 2a, each healthcare provider profile includes success rate information for the associated physician and treatment cost information for the associated physician. The success rate information for a particular physician includes data that relates to the particular physician's success rates in treating different medical conditions. In some implementations, the success rate information is specific enough to enable the physician's success rates in treating different medical conditions to be classified according to demographic, biographic, and/or biological characteristics of the physician's patients. The treatment cost information for a particular physician includes data that relates to the average treatment costs charged by the physician for treating patients with various different medical conditions. FIGS. 8b-8c illustrate one example of how success rate information can be displayed to a user.

The success rate may, for example, represent the percentage of times that the healthcare provider or treatment option completely cured a medical condition associated with the user. However, success may signify any result of a treatment option by a healthcare provider that the user may want to learn more about. The result or outcome that success signifies may be provided by the user to the system. In another example, success may signify that a user has full range of motion after surgery to treat a medical condition. In another example, success may signify that a user did not have an infection after surgery. In another example, success may signify that a user could resume working within 2 weeks of treatment by the healthcare provider.

The collection of healthcare provider profiles 200 may be stored in computer memory or any other computer-readable medium and is searchable. Therefore, the collection of healthcare provider profiles 200 can be searched to identify appropriate healthcare providers for an individual. For example, the collection of healthcare provider profiles 200 can be searched by doctor type, doctor location, doctor success rates, and/or doctor treatment costs to identify appropriate healthcare providers for an individual. In addition, if an individual's location is known, the estimated travel cost associated with traveling from the user's location to a doctor's location in order to receive treatment from the doctor can be calculated based on the doctor's location information that is stored in the healthcare provider profile associated with the doctor.

FIG. 2b is a block diagram that illustrates an example of the success rate information 202(a) included within Dr. Brian Miller's user profile 202 of FIG. 2a. More particularly, Dr. Brian Miller's success rate information 202(a) includes information related to Dr. Brian Miller's success rates in treating various different medical conditions such as, for example, melanoma and acne, as well as information related to Dr. Brian Miller's success rates in treating various different groups of similarly situated patients that suffer from the various different medical conditions. The success rate information may be used to create graphs displayed to a user, such as FIGS. 8b-8c.

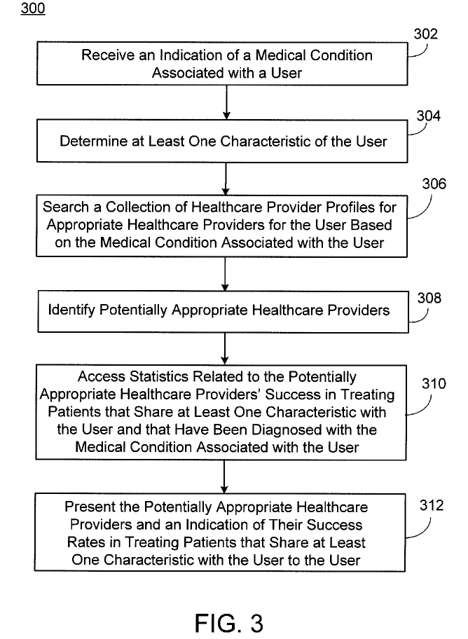

FIG. 3 is a flowchart 300 of an example of a process for identifying and presenting potentially relevant healthcare providers to a user. The process begins when an indication of a medical condition associated with a user is received (302). At least one characteristic of the user also is determined (304). For example, the sex, age, and/or ethnicity of the user may be determined. As illustrated in FIG. 1a, characteristics of the user may be determined based on information input by the user at the same time that the medical condition associated with the user is input. Additionally or alternatively, characteristics of the user may be determined based on information stored in a user profile associated with the user.

A collection of healthcare provider profiles is then searched (306), and a subset of potentially appropriate healthcare providers is identified based on the medical condition associated with the user. For example, if the medical condition associated with a user is melanoma, dermatologists and other physicians with experience treating melanoma may be identified as potentially appropriate healthcare providers. Additionally or alternatively, the subset of potentially appropriate healthcare providers may be identified based on other relevant factors in addition to the medical condition associated with the user. For example, the subset of potentially appropriate healthcare factors may be identified based on location, cost, the healthcare providers in the user's health insurance plan, and/or preferred treatment strategy (e.g., traditional medical treatment versus alternative/homeopathic medical treatment).

For each healthcare provider in the subset of potentially appropriate healthcare providers, statistics related to the healthcare provider's success in treating patients that share at least one characteristic with the user and that have been diagnosed with the medical condition associated with the user are accessed (310). For example, if the user is a female Caucasian between the ages of 41-50 years old that has been diagnosed with melanoma, statistics related to each healthcare provider's success in treating female Caucasians between the ages of 41-50 years old with melanoma may be accessed.

The subset of potentially relevant healthcare providers and an indication of each healthcare provider's success rate in treating patients that share at least one characteristic with the user and that have been diagnosed with the medical condition associated with the user are then presented to the user (312).

Enabling a user to customize the influence exerted by various metrics used to identify appropriate healthcare providers for the user may be useful. For example, enabling a user to customize the influence exerted by each of the various metrics used to identify appropriate healthcare providers may improve the system's ability to identify the most appropriate healthcare providers for the user.

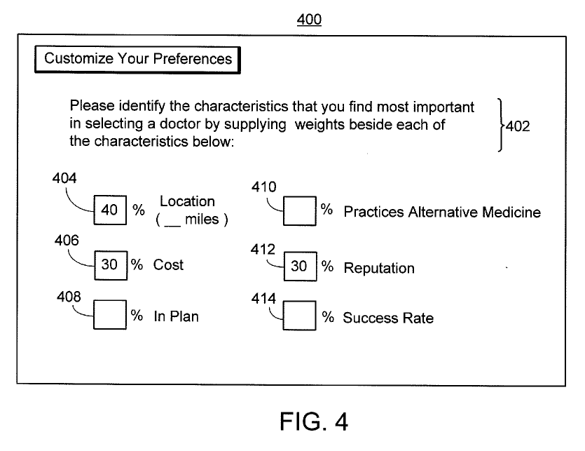

FIG. 4 is an illustration of an example of a GUI 400 that enables a user to customize the weights assigned to metrics used to identify potentially appropriate healthcare providers for the user. The GUI 400 includes a text block 402, a location metric input field 404, a cost metric input field 406, an in plan metric input field 408, a practices alternative medicine metric input field 410, a reputation metric input field 412, and a success rate metric input field 414. The text block 402 includes instructions that explain how a user can user the GUI 400 to customize the metrics used to identify healthcare providers that are potentially appropriate for the user.

In another example of GUI 400, the user may choose to identify potentially appropriate healthcare providers by other metrics. For example, additionally or alternatively, the user may choose metrics such as gender or national origin of the healthcare provider. The system may suggest additional metrics to the user based on an analysis of metrics selected by other users. For example, if the system has determined that a relatively high number of users have chosen to identify potentially appropriate healthcare providers by gender and the user has not selected gender as a metric, the system may recommend that the user choose to identify potentially appropriate healthcare providers by gender.

The GUI 400 enables a user to customize the influence exerted by each of the metrics used to identify appropriate healthcare providers for the user by specifying weights to be applied to each of the metrics used. More particularly, by supplying an appropriate weight in the location metric input field 404, the user can indicate how important a factor location should be in identifying appropriate healthcare providers for the user. Similarly, by supplying an appropriate weight in the cost metric input field 406, the user can indicate how important a factor cost should be in identifying appropriate healthcare providers for the user. By supplying an appropriate weight in the in plan metric input field 408, the user can indicate how important it is to the user that a potential healthcare provider accepts the user's health insurance plan. By supplying an appropriate weight in the practices alternative medicine input metric filed 410, the user can indicate how important it is to the user that a potential healthcare provider practices alternative (e.g., homeopathic) medical techniques. By supplying an appropriate weight in the reputation metric input field 412, the user can indicate how important a factor reputation should be in identifying appropriate healthcare providers for the user. Finally, by supplying an appropriate weight in the success rate input field 414, the user can indicate how important a factor success rate should be in identifying appropriate healthcare providers for the user. In some implementations, a healthcare provider's reputation may be determined based on objective quality ratings provided by a third party. In other implementations, a healthcare provider's reputation may be determined based on feedback supplied by co-users or based on feedback supplied by co-users that are similarly situated to the particular user (e.g., co-users that are in the particular user's social network or co-users that share one or more characteristics with the particular user). As illustrated in FIG. 4, the user has specified that location should account for 40% of a healthcare provider recommendation and cost and reputation should each account for 30% of a healthcare provider recommendation. The metrics illustrated in FIG. 4 as metrics that are used to identify healthcare providers that are potentially appropriate for a user are merely examples. Other customizable metrics also may be used.

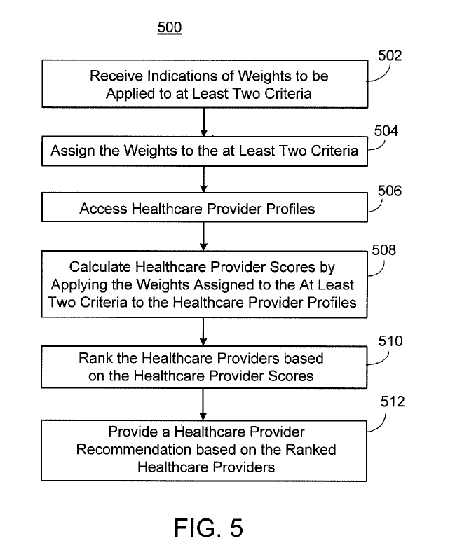

FIG. 5 is a flowchart 500 of an example of a process for identifying appropriate healthcare providers for a user based on customized metrics. The process for identifying appropriate healthcare providers for a user based on customized metrics begins by receiving indications of weights to be applied to at least two criteria to be used in identifying appropriate healthcare providers (502). For example, a user may input weights to be assigned to a healthcare provider's locations and costs in order to identify the healthcare providers that are most appropriate for the user.

After the weights are received from the user, the weights are applied to their corresponding criteria (504) and individual healthcare provider profiles associated with different healthcare providers are accessed (506). Healthcare provider scores are then calculated for each of the different healthcare providers by applying the assigned weights to numerical representations of the criteria maintained in each of the different healthcare provider profiles (508). For example, if location and cost are the two criteria, each of the healthcare provider profiles may maintain a numerical representation of the associated healthcare provider's proximity to a user and a numerical representation of an estimated cost for receiving treatment from the healthcare provider. A healthcare provider score then may be calculated for each healthcare provider by applying the weights specified by the user to the numerical representation of the healthcare provider's proximity to the user and the numerical representation of the estimated cost for receiving treatment from the healthcare provider.

After healthcare provider recommendations have been calculated for the different healthcare providers, the healthcare providers are ranked based on the healthcare provider scores (510). For example, if the user specified that location should be weighted heavily and that cost should be weighted lightly in identifying appropriate healthcare providers, healthcare providers that are in close proximity to the user but that are relatively expensive may be ranked more highly than healthcare providers that are located far away from the user but that are relatively inexpensive.

A healthcare provider recommendation is then provided to the user based on the ranked healthcare providers (512). For example, a predefined number of the most highly ranked healthcare providers may be provided to the user. Additionally or alternatively, all of the healthcare providers that have a healthcare provider score that exceeds a predefined threshold healthcare provider score may be provided to the user. In this manner, the healthcare providers that are most appropriate for the user may be identified and presented to the user.

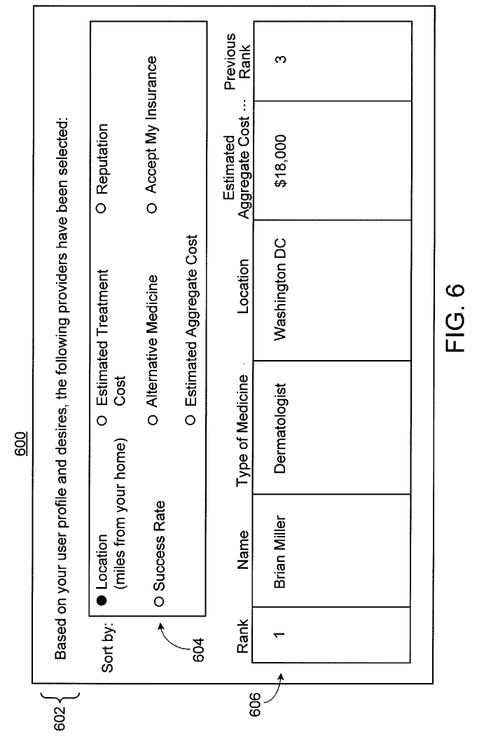

FIG. 6 is an illustration of an example of a GUI 600 that enables a user to sort the healthcare provider recommendations provided in step 512 according to metrics selected by the user. The GUI 600 includes a text block 602 that introduces the information to be presented by the GUI 600, a metric selection input field 604, and a table 606 listing recommended healthcare providers. The metric selection input field 604 allows the user to sort the provided healthcare providers in table 606 by one or more metrics including location, success rate, estimated treatment cost, alternative medicine, estimated aggregate cost, reputation, and/or insurance acceptance.

The table 606 displays recommended healthcare provider information in order of the healthcare provider's ranking based on the healthcare provider scores determined in step 510. The table lists the healthcare provider's current rank, the healthcare provider's name, the type of medicine practiced by the healthcare provider, the healthcare provider's location, the estimated aggregate cost of the treatment, and the healthcare provider's previous rank (before sorting). The information provided in table 606 can be customized by the user to include any information in the healthcare provider profiles 200.

For example, in FIG. 6, the user has selected to sort the healthcare providers by location in the metric selection input field 604, thereby sorting the healthcare providers according to their distance from the user's home. As a result, table 606 displays healthcare provider Dr. Brian Miller first with a rank of one. In addition, the table 606 displays the previous rank for Dr. Miller before the user selected the current sorting metric, so that the user can determine how the current sorting metric has affected the rankings of the healthcare providers. Dr. Miller is ranked number one after the user has selected to sort the healthcare providers by location because Dr. Miller is located in Washington, D.C. and is the closest healthcare provider to the user.

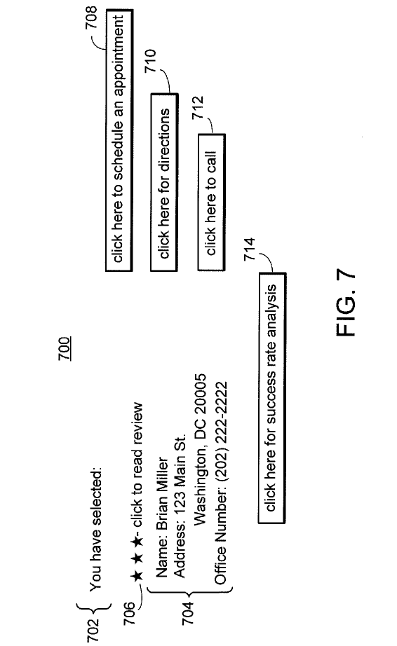

FIG. 7 is an illustration of an example of a GUI 700 that enables the user to learn more about a selected healthcare provider. The GUI 700 includes a first text block 702 that informs the user of the healthcare provider selected, a second text block 704 that provides contact information for the healthcare provider, graphics 706 indicating a rating for the healthcare provider, a button 708 allowing the user to schedule an appointment with the healthcare provider, a button 710 providing directions to the healthcare provider, a button 712 allowing the user to call the healthcare provider, and a button 714 allowing the user to learn more about the success rate of the healthcare provider. In addition, GUI 700 may provide an additional button to search for flights to the healthcare provider's location if the healthcare provider is located more than 50 miles, for example, from the user's home. GUI 700 may also provide an additional button to allow the user to learn more about the medical condition and/or treatment the user has selected. Information about the medical condition and/or treatment may be provided by the website or by a third-party source.

Text block 704 includes the selected healthcare provider's name, the healthcare provider's address, and the healthcare provider's office telephone number. The text block may also include the healthcare provider's mobile telephone number and/or fax number. By clicking on button 712, a user will initiate a call to the healthcare provider's office telephone number in order to speak to a member of that office. By clicking on button 710, a user will receive directions to the healthcare provider's office from the user's home address that may be stored in the user's profile or provided by the user. The directions may be provided by the website or by a third-party source. By clicking on button 708, the user can choose to schedule an appointment with the healthcare provider or determine the availability of the healthcare provider by accessing the healthcare provider's appointment calendar.

Graphics 706 are indicative of a rating associated with the healthcare provider. The rating may be based on an average of all ratings for the healthcare provider by other users of the website or it may be based on ratings provided by one or more third-party organizations. By clicking on the graphics 706 or a button located near the graphics 706, a user can access and read reviews about the healthcare provider written by other users of the website or by the one or more third-party organizations. Graphics 706 allow a user to quickly compare the quality of a selected healthcare provider among the group of provided healthcare providers and also allow the user to learn more about the selected healthcare provider through written reviews.

By clicking on button 714, a user can analyze the success rate of the healthcare provider using different metrics. For example, graphs may illustrate success rate by year, success rate by age, and/or treatment duration by year so that a user can analyze the success rate of a healthcare provider. FIGS. 8a-8c illustrate an example of graphs displayed to the user when the user clicks on button 714. FIG. 8a shows the duration of time needed by the selected healthcare provider from initial examination to successful cure of a medical condition over a given number of years. For example, FIG. 8a shows that it took Dr. Miller more than 150 days to successfully treat a Caucasian female between the ages of 41 and 50 for melanoma in the year 2000. However, Dr. Miller was more effective in 2001, as it took him under 150 days to successfully treat a similar patient for the same medical condition. FIG. 8a may also illustrate the average treatment duration for all dermatologists in the United States. In another example, the user may decide to display an average treatment duration for only those dermatologists in a certain geographic area, with a certain level of experience, with a certain rating/reputation, or for only those that accept the user's insurance. As a result, the user can compare the treatment duration of a selected healthcare provider to that of all or a subset of healthcare providers practicing the same type of medicine.

FIG. 8b illustrates the success rate of a selected healthcare provider in treating a selected medical condition over a given number of years. For example, FIG. 8b shows that Dr. Miller had greater than a 50% success rate in treating melanoma in Caucasian women between the ages of 41 and 50 in years 2000, 2001, 2003, and 2004. The user may notice the positive trend in Dr. Miller's success rate in the last three years of the graph, thereby allowing the user to make a more informed and comfortable decision in selecting Dr. Miller to treat his medical condition. FIG. 8b may also illustrate the average success rate for treating melanoma in similar patients for all or a subset of dermatologists in the United States over the same number of years.

Similarly, FIG. 8c illustrates the success rate of a selected healthcare provider in treating a selected medical condition according to patient age. For example, FIG. 8c shows that Dr. Brian Miller had the greatest success treating melanoma in Caucasian women between the ages of 30 and 40. Another healthcare provider may have less success in that age group, but have better success with younger or older patients. In addition, FIG. 8c may illustrate the average success rate of all or a subset of dermatologists in the United States for similar patients according to patient age. For example, in FIG. 8c, a user can see that Dr. Miller has a higher success rate in patients of all ages than an average dermatologist in the United States.

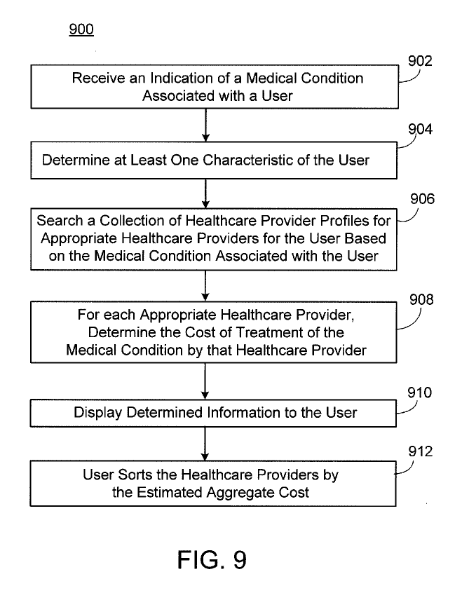

FIG. 9 is a flowchart 900 of an example of a process for selecting a healthcare provider according to treatment cost. A user may be primarily interested in cost if the medical condition associated with the user is not life-threatening. The process begins when an indication of a medical condition associated with a user is received (902), as is described in step 302 shown in flowchart 300. At least one characteristic of the user is also determined (904), as is described in step 304 shown in flowchart 300. A collection of healthcare provider profiles is then searched and a subset of potentially appropriate healthcare providers is identified based on the medical condition associated with the user (906), as is described in step 306 shown in flowchart 300. For each appropriate healthcare provider, the aggregate cost of treatment of the user's medical condition is calculated (908). The aggregate cost of treatment may include the cost of traveling to the healthcare provider including airfare, gasoline usage, housing, meals, rehabilitation, and/or work downtime. In addition, out-of-pocket costs such as insurance deductibles, co-pays, equipment purchases, and/or medication costs may be included in the aggregate treatment cost.

For example, the co-pay costs may be dependent on the number of visits that a user must make to be successfully treated for the medical condition associated with the user. In another example, the costs associated with work downtime may be dependent on the duration of time required to successfully cure the user, as illustrated in FIG. 8a, and the user's income. As a result, the aggregate cost of treatment for a user with a high income may be lower if the user travels to a healthcare provider who successfully cures the user more quickly than if the user selects a local healthcare provider who takes longer to successfully cure the user.

After the aggregate cost for each appropriate healthcare provider is determined, the information is provided to the user (910) through means of a GUI, such as GUI 600. The user may then sort the healthcare providers by the estimated aggregate cost (912). In cases where the medical condition is not life-threatening, cost may be the primary metric of interest to a user and the process shown in flowchart 900 quickly allows a user to determine the lowest cost healthcare provider to treat the user's medical condition.

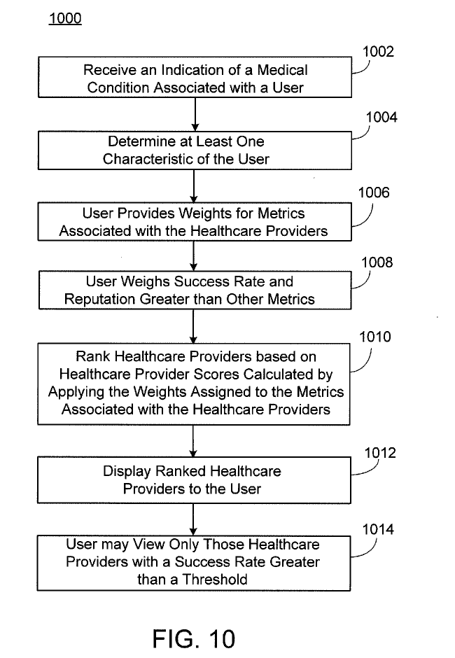

FIG. 10 is a flowchart 1000 of an example of a process for selecting a healthcare provider primarily according to success rate and reputation. A user may be primarily interested in success rate and reputation of a healthcare provider if the medical condition associated with the user is life-threatening. The process begins when an indication of a medical condition associated with a user is received (1002), as is described in step 302 shown in flowchart 300. At least one characteristic of the user is also determined (1004), as is described in step 304 shown in flowchart 300. A user then provides weights for metrics associated with healthcare providers (1006) through the means of a GUI, such as GUI 400. The metrics associated with healthcare providers may include location, cost, insurance plan acceptance, practicing of alternative medicine, reputation, and/or success rate. In providing weights for each metric, a user with a life-threatening medical condition may weigh reputation and success rate more heavily than the other metrics (1008). Based on the weights provided by the user, healthcare providers are ranked according to their calculated healthcare provider score (1010).

For example, a user with a life-threatening medical condition may be more interested in employing the services of a renowned healthcare provider with a high success rate located across the country. According to the metric weights provided by the user, such a renowned healthcare provider would receive a higher score than a local healthcare provider that may be less costly, but also less effective. After the appropriate healthcare providers are ranked, the information is provided to the user (1012) through means of a GUI, such as GUI 600. The user may then choose to sort the healthcare provider by a metric, such as reputation or success rate. In another example, the user may choose only to view those healthcare providers with a success rate greater than a threshold (1014). The threshold success rate may be predetermined by the system or entered by the user.

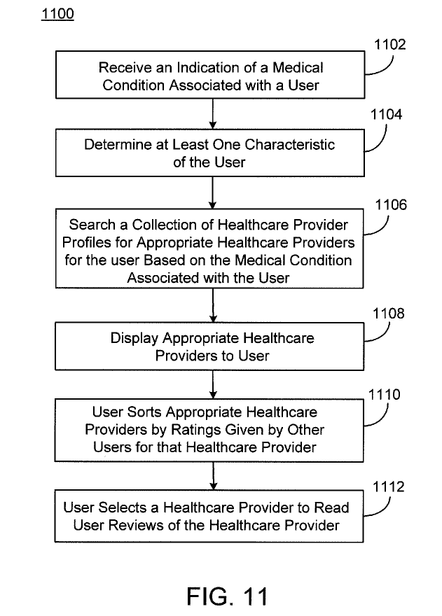

FIG. 11 is a flowchart 1100 of an example of a process for selecting a healthcare provider according the user ratings and reviews. A user may choose to take advantage of social networking by relying on the ratings and reviews of healthcare providers given by other users of the website to select an appropriate healthcare provider. The process begins when an indication of a medical condition associated with a user is received (1102), as is described in step 302 shown in flowchart 300. At least one characteristic of the user is also determined (1104), as is described in step 304 shown in flowchart 300. A collection of healthcare provider profiles is then searched and a subset of potentially appropriate healthcare providers is identified based on the medical condition associated with the user (1106), as is described in step 306 shown in flowchart 300. The information may be displayed to a user (1108) through means of a GUI, such as GUI 600. GUI 600 may be customized to include a column for ratings associated with the appropriate healthcare providers and the user may choose to sort the appropriate healthcare providers by their ratings (1110). If a user wishes to obtain more information about a particular healthcare provider after viewing the provider's rating, the user can select the provider and read user reviews of the provider written by other users (1112).

The rating for each healthcare provider may be determined based on an average of ratings given to the healthcare provider by other users. In one implementation, the user may choose to view the rating of a healthcare provider based on an average of ratings given by all users of the website worldwide. In another implementation, the user may choose to view the rating of a healthcare provider based on an average of ratings given by only users within a specific geographic location. For example, the user may be interested in how others users in his city have rated the healthcare provider, and so, the user may limit the ratings used to calculate the healthcare provider rating to only those of users in his city. In another implementation, the user may wish to know how other users with his medical condition have rated the appropriate healthcare providers. As a result, the user may limit the ratings used to calculate healthcare provider ratings to only those of users sharing the same medical condition associated with the user.

In another implementation, the user may choose to limit the ratings used to calculate healthcare provider ratings to only those of users in his friend list on the website or on another third party service (instant messaging service providers, such as, for example, AIM, ICQ, Yahoo Messenger, and Microsoft Messenger). For example, the user may be friends with other users on the website and trust their judgment more than users who are unknown. By limiting the ratings used to calculate healthcare provider ratings to only those of users on his friend list, the user may be more confident in the ratings. In another implementation, the user may choose to limit the ratings used to calculate healthcare provider ratings to only those of users active in a specific forum or discussion board of the website. For example, the user may be active on a forum associated with his medical condition and wish to limit healthcare provider ratings to only those of other active users of that same forum.

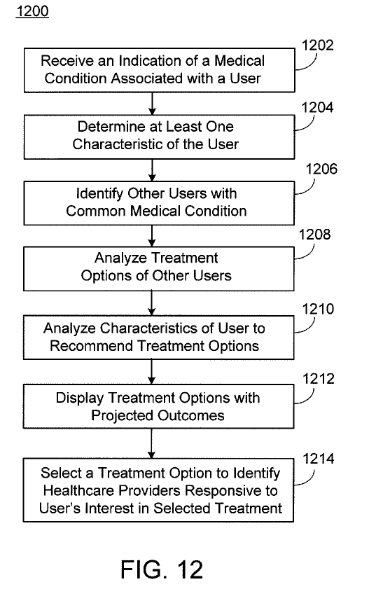

FIG. 12 is a flowchart 1200 of an example of a process for selecting a healthcare provider according to the user's preferred treatment option. A user may choose to take advantage intelligence gained through social networking by relying on treatment options utilized by other users for treating the medical condition associated with the user. The process begins when an indication of a medical condition associated with a user is received (1202), as is described in step 302 shown in flowchart 300. At least one characteristic of the user is also determined (1204), as is described in step 304 shown in flowchart 300. Then, other users with a common medical condition associated with the user are identified (1206).

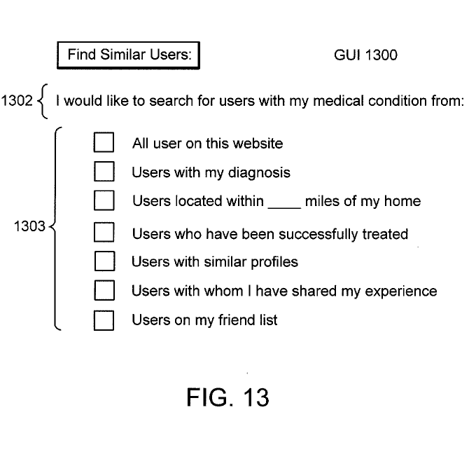

To identify other users with a common medical condition, user profiles associated with the website are searched to identify users who have suffered or are suffering from the medical condition associated with the user. All or only a subset of the user profiles associated with the website may be searched for the common medical condition. It may be beneficial to search only a subset of user profile associated with the website to save system resources and/or allow faster completion of the search. FIG. 13 is an illustration of an example of a GUI 1300 that enables a user to limit the user profiles to be searched. The GUI 1300 includes a text block 1302 instructing the user to select conditions for limiting the users and an input field 1304 allowing the user to select the conditions. The input field 1304 allows the user to limit the user profiles to be searched to all users on the website or only those of users with the same diagnosis, users in a certain geographic location, users who have been successfully treated for the common medical condition, users with similar user profiles, users with whom the user has shared his experiences, and/or users in the user's friend list on the website or on another third party service. For example, a user suffering from the medical condition of melanoma may choose to limit the user profiles searched to only users who have been successfully treated for melanoma within 50 miles of the user's home. In this way, a user may be able to choose between treatment options locally available to the user that have been successful in treating the medical condition associated with the user.

In another implementation, a user may have been diagnosed with melanoma in 2001 and entered the condition into his user profile to learn more about the condition and/or find a healthcare provider to treat the condition. The user may have also logged the progress of his treatment and, ultimately, indicated when he was cured. For example, the user diagnosed with melanoma may have first unsuccessfully treated his condition through chemotherapy for several months. Then, the user may have attempted surgery and indicated in his user profile that he was successfully cured in 2002. A second user could then choose to identify other users whose profiles indicate that they had the same medical condition in the past. In addition, users identified with the same medical condition may be limited to only those users who were successfully treated, such as the user suffering from melanoma above.

In another implementation, a user may choose to search for other users suffering from the same medical condition with similar profiles. The system will then compare at least one characteristic of the user to at least one characteristic of other users suffering from the same medical condition in order to find users with similar profiles. For example, a user suffering from melanoma may be interested in only identifying other users with the same health insurance plan and/or similar income level. In response to such a search, the system will limit the users identified to those sharing the same characteristics of interest as the user. In another example, in response to a search for other users with similar profiles, the system will compare all or a subset of characteristics of the user to the corresponding characteristics of another user. If the correlation or similarity between the two profiles is greater than a threshold amount, then the other user is determined to have a similar profile. For example, a user may indicate in his profile that he is a 25 year-old male with an annual salary of $50,000 living in Washington, D.C. who suffers from melanoma. If the similarity threshold is 75%, then all other users suffering from melanoma who share at least three of the four characteristics relating to the user would be identified. For example, another user suffering from melanoma who is a 25-year-old male living in Washington, D.C. but earning $100,000 a year would be identified as a user with a similar profile.

In another implementation, a user may choose to search for other users suffering from the same medical condition with whom the user has shared his experience. These users may be identified as those active in the same discussion board as the user, contributing to the same chat room as the user, those that have previously emailed or messaged the user, and/or those that have accessed the user's personal website and/or blog. For example a user may post his experiences in treating melanoma on a discussion board of the website. The user may limit his search to only users with the same medical condition who viewed and/or commented on the user's discussion board. In another example, if the user has emailed or messaged other users regarding his experiences in treating melanoma, those users may also be included as those users with whom the user has shared his experiences.

In another implementation, a user may choose to search for other users suffering from the same medical condition who are on the user's friend list on the website or on a third-party service. For example, the user may have a friend list on the website comprising other users the user has accepted as an electronic friend. In another example, the user may have a friend list on a third-party service with at least one friend on the third-party friend list being a member of the website. In both examples, the user may choose to limit the users with the same medical condition to users belonging to at least one of his friend lists.

Once users with a common medical condition are identified, the treatment options associated with those users to treat the medical condition are analyzed (1208). To analyze the treatment options, at least the duration of the treatment, the cost of the treatment, the success rate of the treatment, and the comfort level of the treatment are collected from the identified user profiles. Comfort level may be a number reflecting the pain or discomfort associated with the treatment and/or it may reflect the magnitude of change in the user's everyday activities resulting from the treatment. For example, a user treating melanoma with chemotherapy may have a low level of comfort because of the pain associated with the treatment and also because chemotherapy may limit the ability of the user to spend time with his family. On the other hand, the comfort level of treating melanoma with herbal medicine may be relatively high because there is less pain associated with herbal medicine and it may not limit the ability of the user to spend time with his family.

In an example of analyzing treatment options, the profiles of users identified as having treated melanoma using chemotherapy are used to determine the cost of the treatment, the duration of the treatment, the success of the treatment, and the comfort level of the user. The cost, duration, success, and comfort level of all identified users is then averaged together and presented to the searching user. The same analysis is done for all or a subset of other treatment options used by the identified users to treat the medical condition.

After the treatment options are analyzed, the characteristics of the searching user are analyzed to recommend treatment options to the user (1210). For example, if the characteristics of the user indicate that the user has a high income, then treatment options with a relatively high success rate and relatively high cost may be recommended. In another example, the characteristics of the user may indicate that the user does not prefer to travel, so the system may only recommend treatment options available in close proximity to the user that have a relatively high success rate. In another example, the characteristics of the user may indicate that the user enjoys an active lifestyle, so the system may only recommend treatment options that have a relatively high comfort level.

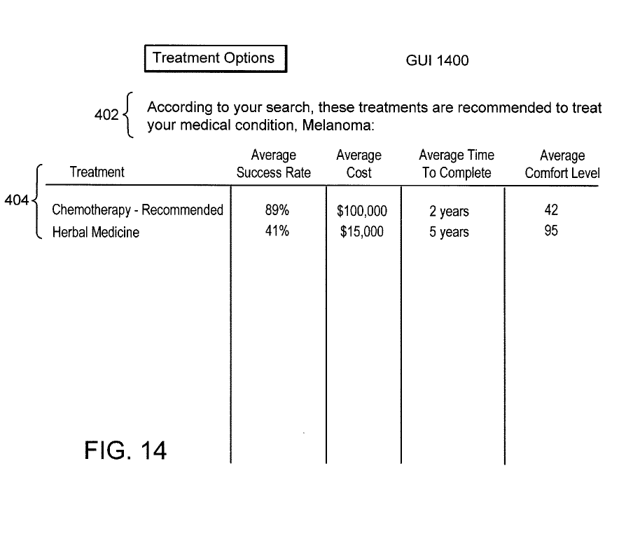

Once the recommended treatment options are determined, the treatment options are displayed to the user (1212). FIG. 14 is an illustration of an example of a GUI 1400 that displays the recommended treatment options to the searching user. The GUI 1400 includes a text block 1402 introducing the information to be presented by GUI 1400 and a table 1404 displaying statistics associated with each treatment option. For example, table 1404 illustrates treatment options recommended to treat melanoma in response to a user's request. The first treatment option available is chemotherapy having a relatively high success rate of 89% and relatively short duration of two years, but also a relatively high cost of $100,000 and relatively low comfort level of 42. The second treatment option is herbal medicine having a relatively low success rate of 41% and a relatively long duration of five years, but a relatively low average cost of $15,000 and a relatively high comfort level of 95. These two treatment options may have been recommended because the user has both a high income and enjoys an active lifestyle.

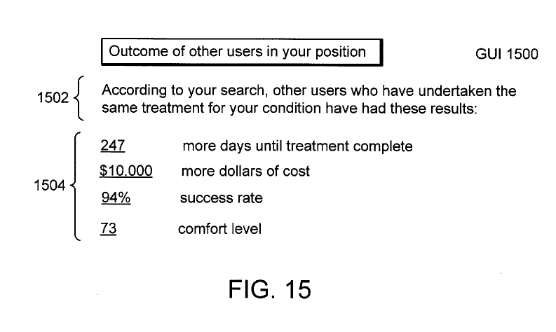

For any treatment option selected by the user, the user may view information regarding the projected outcome of the treatment for the user (1212). FIG. 15 is an illustration of an example of a GUI 1500 that displays the projected outcome of a selected treatment option to the user. The GUI 1500 includes a first text block 1502 introducing the information to be presented by GUI 1500 and a second text block 1504 displaying information about the projected outcome of the selected treatment option. Text block 1504 displays at least the projected number of days until treatment is complete, the projected additional cost of treatment, the projected success rate, and the projected comfort level of the user. For example, text block 1504 illustrates that the user likely has 247 more days until the selected treatment is complete, must likely spend an additional $10,000, will likely have a 94% success rate, and will likely experience a comfort level of 73. The projected outcome information may be especially useful for a user who has partially completed the selected treatment option or wants to switch to the selected treatment option from another treatment option. For example, the success rate of the chemotherapy to treat melanoma may only be 90% for users recently diagnosed with melanoma, but the success rate may rise to 94% for users after the first week of chemotherapy treatment. By viewing the projected outcomes, users may have a better idea of what to expect from continuing a treatment option or by switching to a new treatment option.

The projected outcome information is determined by analyzing the progress of identified users suffering from the same common medical condition. For example, the system may identify two users who treated melanoma with chemotherapy. The system may find that the first user reported a comfort level of 45 in the first week and a comfort level of 70 in the second week. The system may find that the second user reported a comfort level of 51 in the first week and a comfort level of 80 in the second week. Therefore, if the user has not yet started chemotherapy treatment, the system will display a projected comfort level of 48, but if the user is starting his second week of chemotherapy treatment, the projected comfort level displayed will rise to 75.

The user may then select a treatment option and the system will identify healthcare providers in response to the user's interest in the selected treatment (1214). In one implementation, healthcare providers may be identified by searching the user profiles of identified users for the healthcare providers used for each treatment. For example, if the user selected chemotherapy as a treatment option for melanoma, the system will determine all or a subset of the healthcare providers used by the identified users to treat melanoma with chemotherapy. In one implementation, the system will identify all of the healthcare providers who were used by more than a threshold number of users. In another implementation, the system will identify healthcare providers who have a success rate greater than a threshold percentage. In another implementation, the system will use the weights associated with the metrics provided in FIG. 4 to identify the appropriate healthcare providers. In another implementation, the system will identify healthcare providers located in the same city as the searching user. In another implementation, healthcare providers will be identified based on their rating, as discussed above with reference to FIG. 7, being above a certain threshold. In another implementation, healthcare providers may be identified by information associated with the healthcare provider. For example, the profile of a healthcare provider may include areas of specialty the healthcare provider or the healthcare provider's preferred treatment strategy. The profile of the healthcare provider may be supplied by the healthcare provider, a user, or a third-party service. Based on the information included in the healthcare provider profile, providers specializing in the medical condition of interest or frequently employing the treatment option of interest may be identified.

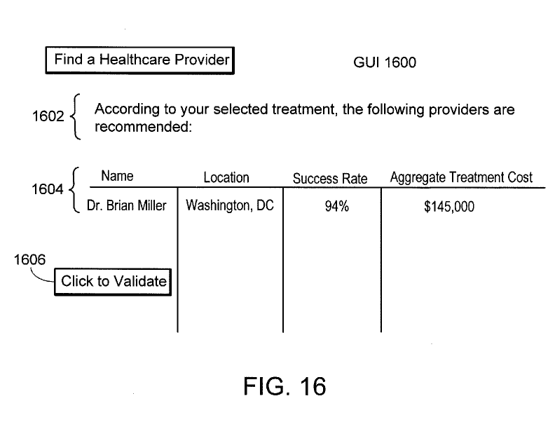

The identified healthcare providers are displayed to the user through a GUI. FIG. 16 is an illustration of an example of a GUI 1600 that displays the identified healthcare providers to the searching user. The GUI 1600 includes a text block 1602 introducing the information to be presented by GUI 1600, a table 1604 displaying information associated with each identified healthcare provider, and a button 1606 for validating the statistics provided for each healthcare provider. In table 1604, at least the name of the healthcare provider, the location of the healthcare provider's office, the success rate for treating the medical condition associated with the user by the selected treatment, and the aggregate treatment cost for each identified healthcare provider is displayed. For example, in GUI 1600, Dr. Miller has been identified to treat melanoma through chemotherapy and his office is located in Washington, D.C. Dr. Miller's success rate for treating melanoma through chemotherapy is 94% and the aggregate cost of the treatment with Dr. Miller is $145,000. The user may appreciate that Dr. Miller's success rate is 5% higher than the average success rate for treating melanoma through chemotherapy. At the same time, however, Dr. Miller's aggregate cost is $45,000 higher than the average aggregate cost for the identified healthcare providers.

Table 1604 may be expanded to include other relevant metrics, such as, for example, average treatment duration for all identified users employing the services of the healthcare provider, average comfort level for all identified users employing the services of the healthcare provider, the rating of the healthcare provider, the healthcare provider's hospital affiliations, the healthcare provider's board certifications, universities attended by the healthcare provider, and/or health insurance plans accepted by the healthcare provider. The user may customize the metrics to be displayed in table 1604.

Button 1606 allows the user to validate the information collected and analyzed by the system. A user may be concerned that information provided by another user on the website is not accurate or that information is falsified to illegally promote a healthcare provider. For example, a rogue user can falsify that he suffered from melanoma, received chemotherapy from Dr. Miller for $10, and was cured in two days. As a result, all information presented to the user regarding Dr. Miller will be skewed and false. Such falsified information could be life-threatening if a user selects a healthcare provider who is not qualified as a result of the misinformation. To avoid such a possibility, in one implementation, the information collected from identified users with the same medical condition can be validated against data regarding treatments provided by healthcare providers. This data can be provided directly by the individual healthcare providers or by a third-party service. As a result, in the example above, the rogue user will be validated against a list of Dr. Miller's patients and, consequently, the falsified information will be removed from the system. In another implementation, all data entered by a user regarding the treatment of a medical condition can be automatically validated to ensure the integrity of the data on the website.

In another implementation, the system may present data entered by other users regarding the treatment of a medical condition to the user so that the user may identify outliers. In another implementation, the system may present data entered by other users regarding the treatment of a medical condition as well as data collected from third-party sources regarding the treatment of a medical condition to the user. The data entered by other users regarding the treatment of a medical condition may be distinguished from the data collected from third-party sources regarding the treatment of a medical condition by, for example, color and/or labels.

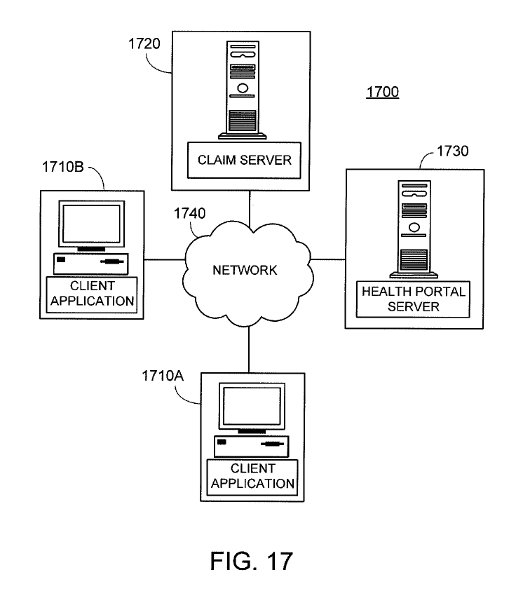

FIG. 17 is an example of a networked computing environment for identifying one or more healthcare providers for a user. The client applications 1710A and 1710B, claim server 1720, and the health portal server 1730 of the networked computing environment 1700 may be distributed geographically and interconnected using a communication network 1740.

The client applications 1710A and 1710B, claim server 1720, and the health portal server 1730 typically each include one or more hardware components and/or software components, such as, for example, a general-purpose computer (e.g., a personal computer) or software on such a computer capable of responding to and executing instructions in a defined manner. Other examples of hardware include a special-purpose computer, a workstation, a server, a device, a component, other physical or virtual equipment or some combination of these capable of responding to and executing instructions. Other examples of software include a program, a piece of code, an instruction, a device, a computer, a computer system, or a combination of these for independently or collectively instructing the user client applications 1710A and 1710B, claim server 1720, and the health portal server 1730 to render, interact, and/or operate as described. Software may be embodied permanently or temporarily in any type of machine, component, physical or virtual equipment, or storage medium capable of providing instructions.

In particular, the client applications 1710A and 1710B may be used, for example, to render and interact with the graphical user interfaces 100-202(a), 400, 600, 700, 1300-1600 discussed with respect to FIGS. 1-2(b), 4, 6, 7, and 13-16. The client applications 1710A and 1710B may each represent a separate user operating a computer to access and modify a user profile at the health portal server 1730 using communication the network 1740. The client applications 1710A and 1710B may include a communications interface used by the communications programs to send communications through the communication network 1740. The communications may include e-mail, audio data, video data, general binary data, or text data (e.g., encoded in American Standard Code for Information Interchange (ASCII) format).

The communication network 1740 typically provides direct or indirect communication between the client applications 1710A and 1710B, the claim server 1720, and the health portal server 1730, irrespective of physical separation. Examples of the communication network 1740 include the Internet, the World Wide Web, WANs, LANs, analog or digital wired and wireless telephone networks (e.g., Public Switched Telephone Network (PSTN), Integrated Services Digital Network (ISDN), and a type of Digital Subscriber Line (DSL)), radio, television, cable, or satellite systems, and other delivery mechanisms for carrying data. The communication network 1740 may include, for example, a wired, wireless, cable or satellite communication pathway.

The claim server 1720 may be, for example, associated with a healthcare provider (e.g., a doctor's office), a health insurance provider (e.g., a “health maintenance organization” or HMO), a healthcare billing processor, or another organization. Also, the claim server 1720 may be configured or programmed to process health information (e.g., a bill from a doctor's office) and generate claims from the processed health information. Generating a claim may include sending data related to the claim to the health portal server 1730 using the network 1740.

The health portal server 1730 may be configured to interact with the client application 1710A and 1710B and the claim server 1720 to enable a healthcare provider recommendations to be personalized using the network 1740. In particular, the health portal server may receive information relating to healthcare claims through communication with a claim server 1720. The health portal server 1730 may process the information relating to healthcare claims and provide recommendations of healthcare providers to client application 1710A and 1710B. Upon receiving an indication that a user has appropriately selected a representation, the health portal server 1730 may provide additional information about a healthcare provider to the client application 1710A or 1710B. The health portal server 1730 may also enable additional functionality, such as, for example, interaction with health information generally or specific to a health claim or profile, facilitate user-to-user communication through, forums or newsgroups, or send reminders or notification relating to health information.

Because the computer-based system for performing the operations described above may be particularly useful in the context of enabling a user to access a health portal, the systems and operations described previously described were directed to a healthcare environment. Nevertheless, the system and operations disclosed herein may be implemented to display information in contexts other than healthcare. For example, the system and operations disclosed herein may be implemented to display information in contexts of financial information and/or real estate information.

The described systems, methods, and techniques may be implemented in digital electronic circuitry, computer hardware, firmware, software, or in combinations of these elements. Apparatuses embodying these techniques may include appropriate input and output devices, a computer processor, and a computer program product tangibly embodied in a machine-readable storage device for execution by a programmable processor.

A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed application-specific integrated circuits (ASICs).

Various modifications may be made. For example, useful results still may be achieved if steps of the disclosed techniques are performed in a different order and/or if components in the disclosed systems are combined in a different manner and/or replaced or supplemented by other components.

What is claimed is:

1. A computer implemented method of generating a healthcare provider recommendation that is personalized for a particular user, the method comprising:
maintaining a user profile for the particular user that includes at least one characteristic of the particular user;
receiving an indication of a medical condition associated with the particular user;
accessing healthcare provider profiles for at least two healthcare providers, two or more of the healthcare provider profiles each corresponding to a single healthcare provider that treats the medical condition and including statistics that are related to the individual healthcare provider's treatment of one or more patients who have been diagnosed with the medical condition and who have the at least one characteristic in common with the particular user, wherein the at least one characteristic in common with the particular user is different than a shared diagnosis of the medical condition; and
providing a personalized healthcare provider recommendation to the particular user based on the accessed healthcare provider profiles, wherein the healthcare provider recommendation identifies at least one of the healthcare providers to the particular user and provides the particular user with access to the statistics that are related to the healthcare provider's treatment of one or more patients who have been diagnosed with the medical condition and who have the at least one characteristic in common with the particular user.

2. The computer implemented method of generating a healthcare provider recommendation that is personalized for a particular user of claim 1, wherein
the at least one characteristic of the particular user comprises an age range, and
the statistics that are related to the individual healthcare provider's treatment of one or more patients who have been diagnosed with the medical condition and who have the at least one characteristic in common with the particular user comprise statistics related to the individual healthcare provider's success rate in treating one or more patients who have been diagnosed with the medical condition and who fall within the age range.

3. The computer implemented method of generating a healthcare provider recommendation that is personalized for a particular user of claim 1 further comprising:
accessing the user profile to identify the at least one characteristic; and
comparing the at least one identified characteristic against information in a collection of healthcare provider profiles to identify the at least two healthcare provider profiles.

4. The computer implemented method of generating a healthcare provider recommendation that is personalized for a particular user of claim 1, wherein
the at least one characteristic of the particular user comprises demographic characteristic, and
the statistics that are related to the individual healthcare provider's treatment of one or more patients who have been diagnosed with the medical condition and who have the at least one characteristic in common with the particular user comprise statistics related to the individual healthcare provider's success rate in treating one or more patients who have been diagnosed with the medical condition and share the demographic characteristic.

5. The computer implemented method of generating a healthcare provider recommendation that is personalized for a particular user of claim 1, wherein
the at least one characteristic of the particular user comprises an indication of a race of the particular user, and
the statistics that are related to the individual healthcare provider's treatment of one or more patients who have been diagnosed with the medical condition and who have the at least one characteristic in common with the particular user comprise statistics related to the individual healthcare provider's success rate in treating one or more patients who have been diagnosed with the medical condition and that are of the same race as the particular user.

6. The computer implemented method of generating a healthcare provider recommendation that is personalized for a particular user of claim 1, wherein
the at least one characteristic of the particular user comprises an indication of a secondary medical condition of the particular user, and
the statistics that are related to the individual healthcare provider's treatment of one or more patients who have been diagnosed with the medical condition and who have the at least one characteristic in common with the particular user comprise statistics related to the individual healthcare provider's success rate in treating one or more patients who have been diagnosed with the medical condition and the secondary medical condition.

7. The computer implemented method of generating a healthcare provider recommendation that is personalized for a particular user of claim 1 further comprising generating a ranking of the at least two healthcare providers based on the statistics that are related to each of the individual healthcare provider's treatment of one or more patients who have been diagnosed with the medical condition and who have the at least one characteristic in common with the particular user, wherein providing a personalized healthcare provider recommendation to the particular user based on the accessed healthcare provider profiles comprises providing a personalized healthcare recommendation to the particular user based on the ranking of the at least two healthcare providers.

8. The computer implemented method of generating a healthcare provider recommendation that is personalized for a particular user of claim 1, wherein the statistics are statistics related to the healthcare provider's treatment of the one or more patients who have been diagnosed with the medical condition.

9. The computer implemented method of generating a healthcare provider recommendation that is personalized for a particular user of claim 8, wherein the statistics are statistics related to the healthcare provider's treatment of the one or more patients who have the at least one characteristic in common with the particular user

10. The computer implemented method of generating a healthcare provider recommendation that is personalized for a particular user of claim 1, wherein the one or more patients who have been diagnosed with the medical condition and who have the at least one characteristic in common with the particular user are patients affiliated with the particular user.

11. A computer implemented method of generating a healthcare provider recommendation for a user, the method comprising:
receiving an indication of a medical condition associated with a user;
identifying two or more healthcare providers that treat the medical condition;
for each identified healthcare provider that treats the condition, estimating an average cost for receiving treatment for the medical condition from the healthcare provider;
providing a healthcare provider recommendation to the user based on estimated average costs for receiving treatment for the medical condition, wherein the healthcare provider recommendation identifies one of the healthcare providers to the particular user and enables the user to access the estimated average cost for receiving treatment for the medical condition from the healthcare provider.

12. The computer implemented method of generating a healthcare provider recommendation for a user of claim 11, wherein estimating the average cost for receiving treatment for the medical condition from the healthcare provider comprises estimating a travel cost for the user that includes projected costs for traveling to and from the healthcare provider for treatment of the medical condition.

13. The computer implemented method of generating a healthcare provider recommendation for a user of claim 11 further comprising, for each identified healthcare provider that treats the condition, accessing statistics that are related to the healthcare provider's treatment of one or more patients who have been diagnosed with the medical condition and who have at least one characteristic in common with the particular user, wherein providing a healthcare provider recommendation to the user comprises providing a healthcare recommendation to the user based on statistics related to the healthcare providers' treatment of one or more patients who have been diagnosed with the medical condition and who have at least one characteristic in common with the particular user.

14. A computer implemented method of generating a healthcare provider recommendation that is personalized for a particular user, the method comprising:
maintaining a set of criteria for ranking healthcare providers, the set of criteria including at least two criteria for ranking healthcare providers;
receiving indications of weights to be assigned to each of the at least two criteria from a user;
in response to receiving indications of weights to be assigned to each of the at least two criteria from the user, assigning the weights to each of the at least two criteria;
accessing healthcare provider profiles for at least two healthcare providers, each of the healthcare provider profiles corresponding to an individual healthcare provider and including quantitative representations of each of the at least two criteria;
for each of the at least two healthcare providers, calculating a healthcare provider score by applying the weights assigned to each of the at least two criteria to the quantitative representations of each of the at least two criteria;
ranking the at least two healthcare providers based on their calculated healthcare provider scores; and
providing a healthcare provider recommendation to the user based on ranking the at least two healthcare providers.

15. A computer implemented method of generating a healthcare provider recommendation that is personalized for a particular user, the method comprising:
maintaining a user profile for the particular user that includes at least one characteristic of the particular user;
receiving an indication of a medical condition associated with the particular user;
accessing healthcare provider profiles for at least two healthcare providers, two or more of the healthcare provider profiles each corresponding to a single healthcare provider that treats the medical condition and including statistics that are related to the individual healthcare provider's treatment of one or more patients who have been diagnosed with a related medical condition and who have the at least one characteristic in common with the particular user; and
providing a personalized healthcare provider recommendation to the particular user based on the accessed healthcare provider profiles, wherein the healthcare provider recommendation identifies at least one of the healthcare providers to the particular user and provides the particular user with access to the statistics that are related to the healthcare provider's treatment of one or more patients who have been diagnosed with the related medical condition and who have the at least one characteristic in common with the particular user.

16. The computer implemented method of generating a healthcare provider recommendation that is personalized for a particular user of claim 15, wherein the one or more patients who have been diagnosed with the medical condition and who have the at least one characteristic in common with the particular user are patients affiliated with the particular user.
